(19) United States
(12) Patent Application Publication
(10) Pub. No.: US 2020/0193965 A1
(43) Pub. Date: Jun. 18, 2020

(54) CONSISTENT AUDIO GENERATION CONFIGURATION FOR A MULTI-MODAL LANGUAGE INTERPRETATION SYSTEM

(71) Applicant: Language Line Services, Inc., Monterey, CA (US)

(72) Inventors: Jeffrey Cordell, Carmel, CA (US); Lindsay D'Penha, Carmel, CA (US); Julia Berke, Carmel, CA (US)

(73) Assignee: Language Line Services, Inc., Monterey, CA (US)

(21) Appl. No.: 16/219,837

(22) Filed: Dec. 13, 2018

(51) Int. Cl. G10L 15/00; H04M 3/51; G06F 17/28; G10L 15/22

(52) U.S. Cl. CPC G10L 15/005; H04M 3/5183; G10L 2015/225; G10L 15/22; G06F 17/289

(57) ABSTRACT

A configuration is implemented via a processor to receive a request for spoken language interpretation of a user query from a first spoken language to a second spoken language. The first spoken language is spoken by a user situated at an audio-based device that is remotely situated from the customer care platform. The user query is sent from the audio-based device by the user to the customer care platform. The configuration performs, at a language interpretation platform, a first spoken language interpretation of the user query from the first spoken language to the second spoken language. Further, the configuration transmits, from the language interpretation platform to the customer care platform, the first spoken language interpretation so that a customer care representative speaking the second spoken language understands the first spoken language being spoken by the user.

### BACKGROUND

### 1. Field

This disclosure generally relates to the field of contact center platforms. More particularly, the disclosure relates to language interpretation systems utilized by contact center platforms.

### 2. General Background

A customer care environment is a context in which human-spoken language interpretation is often needed. For instance, a user speaking a language other than English, which is referred to herein as a limited English proficiency user (“LEP”), may call a remote customer service center and be connected with a customer care representative who only speaks English. For example, the LEP user may have a question about his or her insurance policy, call a customer care phone number corresponding to the LEP user's insurance company, and be routed to an English-speaking customer care representative to answer the LEP's question. To help facilitate an understanding of the communication for both the LEP user and the English-speaking customer care representative, the customer service center will often route the phone call to a third-party language interpretation service in which the language interpretation is performed via human interpreter, a machine interpreter, or some combination thereof.

Given various contexts, fields of expertise, etc., the same language interpreter may not be used for an entire phone call. For example, an LEP user may call an insurance company to ask policy-specific questions, to which a first human language interpreter, from the third-party language interpretation service, with a general knowledge base with respect to insurance is brought into the communication. After asking a few general questions about his or her insurance policy, the LEP user may then ask some medical-specific questions, for which the first human language interpreter does not have expertise, associated with the insurance policy. Accordingly, the first human language interpreter may ask that the LEP and the English-speaking customer care representative halt their conversation until the first human language interpreter is able to transition the phone call to a second human language interpreter, or other language interpretation resource, to further perform language interpretation for the LEP and the English-speaking customer care representative.

As a result, the LEP user experiences significant wait times, delays in obtaining information, etc. Therefore, conventional language interpretation systems utilized by contact center platforms are inefficient and cumbersome.

### SUMMARY

A configuration is implemented to receive, with a processor from a customer care platform, a request for spoken language interpretation of a user query from a first spoken language to a second spoken language. The first spoken language is spoken by a user situated at an audio-based device that is remotely situated from the customer care platform. The user query is sent from the audio-based device by the user to the customer care platform;

The configuration performs, at a language interpretation platform, a first spoken language interpretation of the user query from the first spoken language to the second spoken language. Further, the configuration transmits, from the language interpretation platform to the customer care platform, the first spoken language interpretation so that a customer care representative speaking the second spoken language understands the first spoken language being spoken by the user. Additionally, the configuration receives, at the language interpretation platform from the customer care platform, a customer care response in the second spoken language.

Moreover, the configuration performs, at the language interpretation platform via a plurality of language interpretation resources, a second spoken language interpretation of the customer care response from the second spoken language to the first spoken language. The configuration also generates, with the processor, audio data corresponding to the second spoken language interpretation of the customer care response. The audio data represents a singular voice for the plurality of language interpretation resources. Finally, the configuration transmits, with the processor, the audio data to the customer care platform so that the customer care platform sends the audio data to the audio-based device for consumption at the audio-based device without rendering of audio data in the first spoken language.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a consistent audio generation configuration.

FIG. 2 illustrates the internal components of the multi-modal language interpretation platform illustrated in FIG. 1.

FIG. 3A illustrates a language interpretation escalation configuration.

FIG. 3B illustrates another example of the language interpretation escalation configuration illustrated in FIG. 3A.

FIG. 4 illustrates a process that may be utilized to generate consistent audio for an interpreted/translated response to a question from the LEP user sent to the customer care platform.

### DETAILED DESCRIPTION

A consistent audio generation configuration is provided for a multi-modal language interpretation system (i.e., language interpretation via human language interpreter, machine interpreter, or a combination thereof). Being in operable communication with, or integrated within, a customer contact center, the multi-modal language interpretation system is able to generate and insert audio, which corresponds to a language interpretation, into a communication between an LEP user and the customer contact center. The audio is associated with a language interpretation performed by the one or more language interpretation resources selected by the multi-modal language interpretation system for performing the language interpretation. Whether the same language interpretation resource, or a plurality of different language interpretation resources, are utilized by the multi-modal language interpretation system to perform the language interpretation, the LEP user hears the same consistent voice emanating from the communication device of the LEP user.

In one embodiment, the audio is inserted instead of the voice of the customer representative at the customer contact center. In other words, the customer contact center may be conversant in a different language than the LEP. For example, the customer contact center may only have English-speaking representatives that may be unable to understand the questions asked by the LEP user. Accordingly, the English-speaking representative is able to speak into an audio reception device (e.g., smartphone, landline telephone, microphone, etc.), yet that English audio is not heard by the LEP; instead, the multi-modal language interpretation system may translate the English into Spanish and transmit the Spanish audio to the customer contact center for forwarding to the LEP. Therefore, the LEP user does not have to listen to a remote translation of English into the LEP's native language (e.g., Spanish); rather, the LEP user only hears the audio of the translated response to the LEP user's question.

Further, the LEP user is insulated from any language interpretation resource modifications performed by the multi-modal language interpretation system. Even if the multi-modal language interpretation system modifies the type of language interpretation resources utilized (e.g., an escalation from a machine interpreter to a human interpreter), the LEP user will be insulated from such resource transitions. In other words, the multi-modal language interpretation system inserts a consistent audio stream independent of a particular language interpretation resource selected for performing language interpretation.

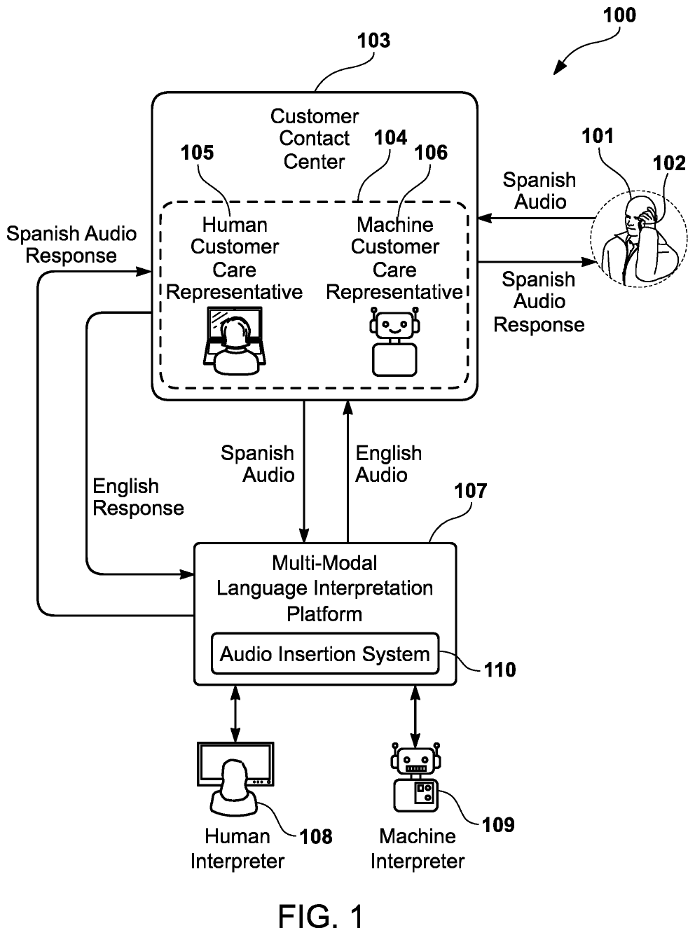

FIG. 1 illustrates a consistent audio generation configuration 100. An LEP user 101 may utilize an audio-based communication device 102 (e.g., smartphone, landline telephone, microphone, etc.) to remotely communicate with a customer contact center 103. For instance, the customer contact center 103 may be a call center for an insurance company that provides customer service regarding users' insurance policies. (An insurance company is provided only as an example since other types of product and/or service providers may be associated with the customer care center 103.)

In one embodiment, the LEP user 101 speaks his or her native language (e.g., Spanish) into the communication device 102. Further, the communication device 102 transmits the audio received from the LEP user 101 to the customer contact center 103. (The customer care center 103 is illustrated only for illustrative purposes since a variety of services other than customer care may be provided by an entity in communication with the LEP user 101) For example, the LEP user 101 may have a question with respect to his or her insurance policy.

At the customer care center 103, a group of customer care representatives 104 (including, but not limited to, human customer care representatives 105 and/or machine customer care representatives 106) are available to answer questions from the LEP user 101 and other users. In one embodiment, the group of customer care representatives 104 is only proficient in a language (e.g., English) other than that of the LEP user 101. Accordingly, the customer care center 103 forwards the Spanish audio to a multi-modal language interpretation platform 107, which may have a human interpreter 108, a machine interpreter 109, or a combination therefore that may translate the Spanish audio into English audio. The language interpretation platform 107 then forwards the English audio to the customer care center 103 so that the one of the customer care representatives 104 may understand the question asked by the LEP user 101.

Further, the customer care representative 104 may respond to the question in English. The customer care center platform 103 sends the English response to the multi-modal language interpretation platform 107 so that the multi-modal language interpretation platform 107 may translate the response into Spanish.

In one embodiment, the multi-modal language interpretation platform 107 has integrated therein, or is in operable communication with, an audio insertion system 110. Irrespective of the particular language interpretation resource (e.g., the human interpreter 108 and/or the machine interpreter 109) selected for language interpretation, the audio insertion system generates a consistent audio stream based on the translation of the contact center representative's response. Whether or not multiple language interpretation resources of the same, or a different, type are utilized throughout the course of a live spoken language interpretation, the multi-modal language interpretation platform 107 generates an audio stream (e.g., via a voice synthesizer) so that the contact care representative's response appears to be delivered to the LEP user 101 from a single source. In other words, from the perspective of the LEP user 101, the contact care representative is speaking directly with the LEP user 101 without any inclusion of a language interpreter. The audio corresponding to the contact center representative appears to be a communication being sent directly to the LEP user 101 from the customer care representative in the native language of the LEP user 101.

Rather than having to utilize computing resources to deliver multiple audio steams from different language interpretation resources, the multi-modal language interpretation platform 107 improves the functioning of a computer by using a single audio stream for delivery of a response to the LEP user 101. Accordingly, less computational resources are needed. Further, the quality of the audio delivery is improved because a single audio stream, rather than multiple audio streams for a contact center response in a non-LEP language and a translation, is delivered by the multi-modal language interpretation platform 107. Further, the multi-modal language interpretation platform 107 improves the quality of the audio steam itself by removing consecutive interpretation (i.e., each participant speaks and waits for a translation). By way of contrast, the multi-modal language interpretation platform 107 allows for simultaneous language interpretation in which participants may speak without waiting for any interpretation since the interpretation is not even apparent to the LEP user 101, thereby resulting in reduced customer contact communication times and increased computing resource availability.

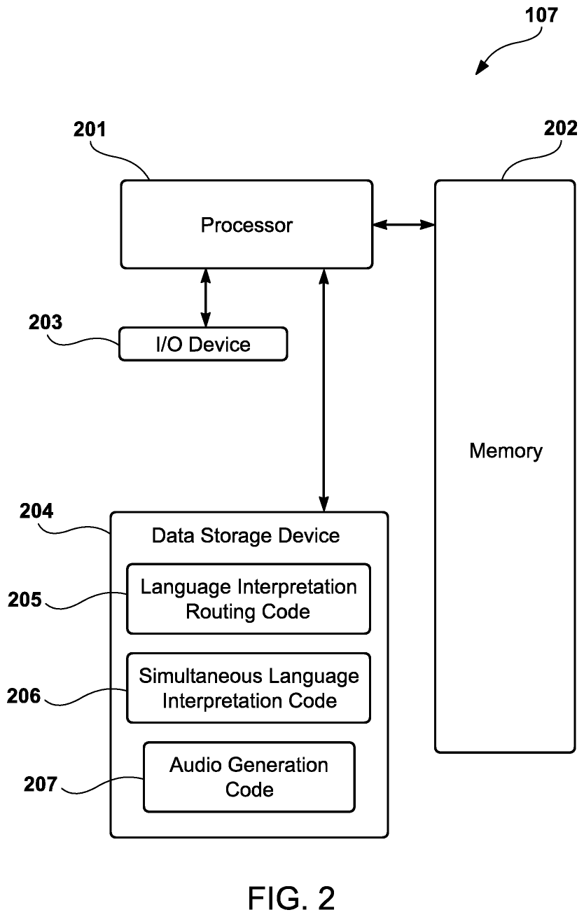

FIG. 2 illustrates the internal components of the multi-modal language interpretation platform 107 illustrated in FIG. 1. A processor 201 is in operable communication with a memory device 202, one or more input/output (“I/O”) devices 203, and a data storage device 204. Further, the processor 201 loads various code (e.g., language interpretation routing code 205, simultaneous language interpretation code 206, and audio generation code 207) from the data storage device 204 into the memory device 202.

The processor 201 utilizes the language interpretation routing code 205 to route the language interpretation request to an available language interpreter (e.g., human interpreter 108 and/or machine interpreter 109). Further, the processor 201 transitions the language interpretation request from one language interpretation resource to another, as the processor 201 deems necessary to complete the language interpretation according to one or more quality control criteria. For example, the processor 201 may determine that a machine interpretation is not performing according to one or more quality control (“QC”) criteria, and may escalate the language interpretation to the human interpreter 108.

Further, the processor 201 utilizes the simultaneous language interpretation code 206 to insert audio, corresponding to the language of the LEP user 101, into the response sent to the audio-based device 102. Accordingly, the LEP user 101 does not have to hear the audio of the interpretation performed by the available language interpreter performing the language interpretation from Spanish into English, but rather can hear only the Spanish translation of the response.

Additionally, the processor 201 utilizes the audio generation code 207 to generate audio corresponding to the translated Response. For example, the English response prepared by the customer care agent 104 is translated into Spanish by the processor 201. Further, in one embodiment, the processor 201 generates a voice (e.g., via a voice synthesizer) that corresponds to the translated English response in Spanish. In other words, the customer care agent 104 may verbalize an English response that is not heard by the LEP user 101, and then the processor 201 may generate an audio stream that is in a voice that is different from the customer care agent 104, which is heard by the LEP user 101.

In another embodiment, the processor 201 may generate an audio stream that corresponds to the voice of the customer care agent 104. For example, the processor 201 may access a database of pre-recorded audio data, such as that of the customer care agent 104. The processor 201 may then utilize the audio generation code 207 to manipulate the pre-recorded audio data to match that of the customer care agent 104. Accordingly, the LEP user 101 may hear the particular, or substantially similar, voice of the customer care agent 104 in Spanish even though the customer care agent 104 did not utter the response in Spanish.

Accordingly, whether or not multiple customer care agents 104 (human and/or machine) are involved in a particular language interpretation, the LEP user 101 is insulated from any such transition. A singular interface is presented to the LEP user 101 so that the LEP user 101 only hears a single audio stream, even if multiple English-speaking customer care agents and/or multiple language interpretation resources were involved in preparation of the Spanish response to the LEP user 101.

In one embodiment, the audio-based device 102 is enough for the LEP user 101 to participate in the communication with the customer care agent 104. In another embodiment, a display-based device (e.g., smartphone, tablet device, desktop computer, laptop computer, virtual reality (“VR”) headset, augmented reality (“AR”) glasses, smartwatch, etc.) is used in conjunction with, or as an alternative to, the audio-based device 102. Further, the processor 201 may also generate imagery and manipulate that imagery to coincide with the audio stream generated by the audio generation code 207. In other words, the processor 201 may manipulate imagery (e.g., picture of the customer care agent 104, avatar, emoji, etc.) to appear as if the imagery is verbalizing the translated audio response. As a result, voice-based interpreters may provide an interpretation that appears to be a video remote interpretation (“VRI”), but instead is utilizing imagery and is verbalizing, with possibly a different voice, the interpretation/translation performed by the voice-based interpreter.

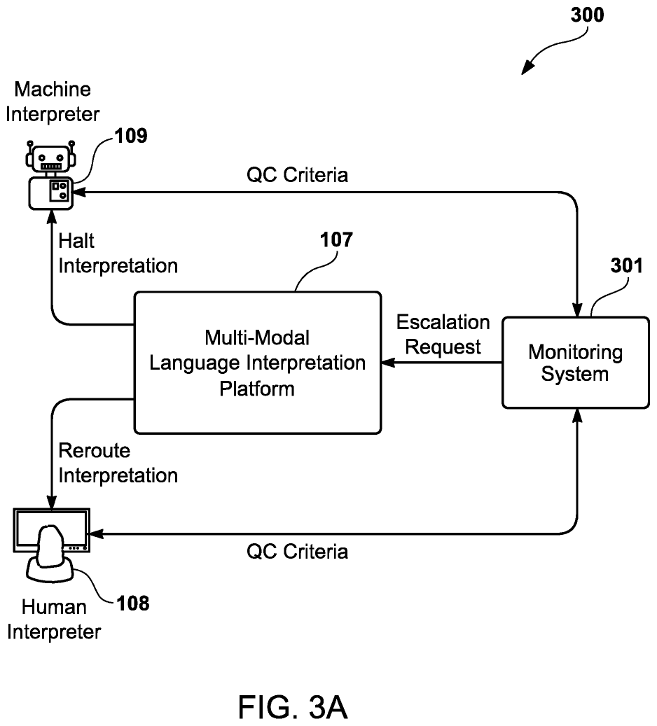

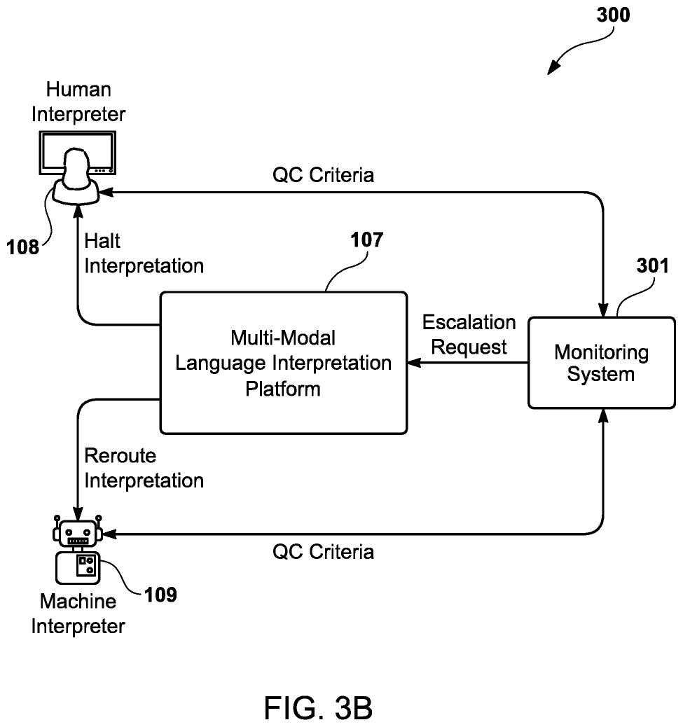

FIG. 3A illustrates a language interpretation escalation configuration 300. The language interpretation platform 107 illustrated in FIG. 1 may route a language interpretation request to a machine language interpreter 109. Further, the language interpretation platform 107 may be in operable communication with a monitoring system 301 that monitors various QC criteria (e.g., accuracy, speed, etc.) Upon determining that the machine language interpreter 109 is not performing a language interpretation that meets the QC criteria, the monitoring system 301 sends a message to the language interpretation platform 107 to request escalation (i.e., rerouting) of the language interpretation from the machine interpreter 109 to the human interpreter 108. The language interpretation platform 107 may then transition the language interpretation from the machine interpreter to the human interpreter 108. As yet another alternative, the language interpretation platform 107 may transition the language interpretation from the machine interpreter 109 to a different machine interpreter. Yet, the language interpretation platform 107 may still utilize the audio generation code 207 to generate audio to essentially insulate the LEP user 101 from any such transition.

Further, FIG. 3B illustrates another example of the language interpretation escalation configuration 300 illustrated in FIG. 3A. The language interpretation platform 107 may have initially routed the language interpretation to the human interpreter 108. However, the interpretation may involve some terminology/phraseology (e.g., medical questions) outside the skill set of the particular human interpreter 108. Accordingly, the monitoring system 301 may detect such an issue (e.g., via pauses that exceed a predetermined time threshold, feedback from the LEP user 101, etc.), and may request that the language interpretation platform 107 transition the language interpretation to the machine interpreter 109. Alternatively, the monitoring system 301 may request that the machine interpreter 109 be utilized to assist the human interpreter 108 in the interpretation/translation. As yet another alternative, the monitoring system 301 may request a different human interpreter, with more expertise in the given skill set, assist the human interpreter 108. As yet another alternative, the language interpretation platform 107 may transition the language interpretation from the human interpreter 108 to a different human interpreter. The language interpretation platform 107 may still utilize the audio generation code 207 to generate audio to essentially insulate the LEP user 101 from any such transition.

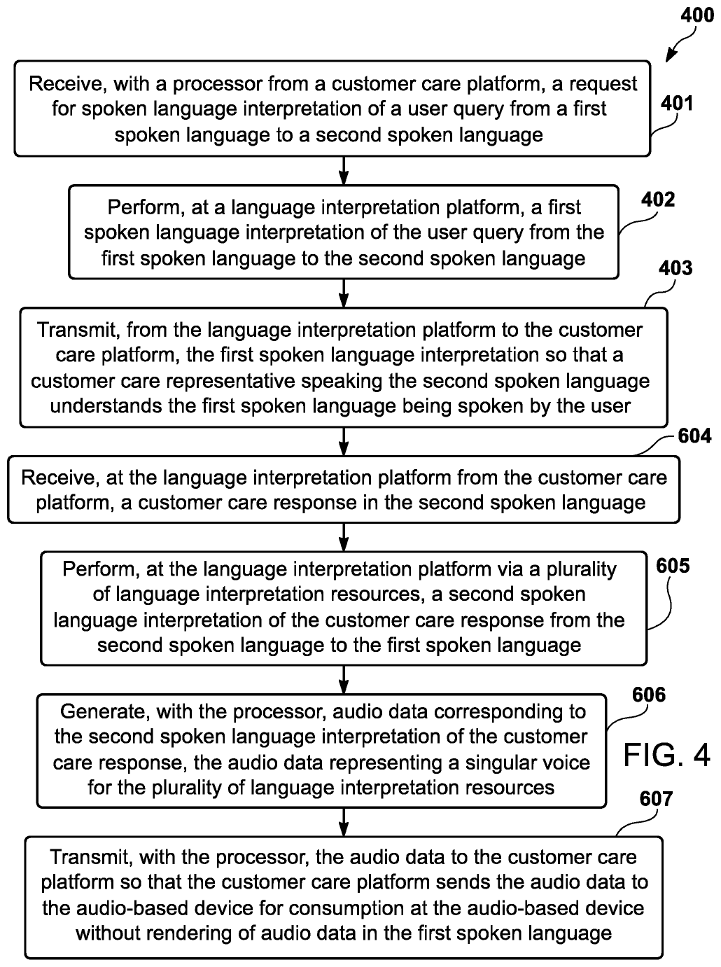

FIG. 4 illustrates a process 400 that may be utilized to generate consistent audio for an interpreted/translated response to a question from the LEP user 101 sent to the customer care platform 104. At a process block 401, the process 400 receives, with the processor 201 (FIG. 2) from the customer care platform 104, a request for spoken language interpretation of a user query from a first spoken language to a second spoken language. The first spoken language is spoken by a user situated at an audio-based device that is remotely situated from the customer care platform 104. The user query is sent from the audio-based device 102 (FIG. 1) by the LEP user 101 to the customer care platform 104.

Further, at a process block 402, the process 400 performs, at a language interpretation platform, a first spoken language interpretation of the user query from the first spoken language to the second spoken language. Additionally, at a process block 403, the process 400 transmits, from the language interpretation platform 107 to the customer care platform 103, the first spoken language interpretation so that a customer care representative 104 speaking the second spoken language understands the first spoken language being spoken by the LEP user 101.

In addition, at a process block 404, the process 400 receives, at the language interpretation platform 107 from the customer care platform 103, a customer care response in the second spoken language. At a process block 405, the process 400 performs, at the language interpretation platform 103 via a plurality of language interpretation resources, a second spoken language interpretation of the customer care response from the second spoken language to the first spoken language. Moreover, at a process block 406, the process 400 generates, with the processor 201, audio data corresponding to the second spoken language interpretation of the customer care response. The audio data represents a singular voice for the plurality of language interpretation resources. Finally, at a process block 407, the process 400 transmits, with the processor 201, the audio data to the customer care platform 103 so that the customer care platform 103 sends the audio data to the display-based device for consumption at the display-based device 101 without rendering of audio data in the first spoken language.

A computer is herein intended to include any device that has a general, multi-purpose or single purpose processor as described above. For example, a computer may be a PC, laptop computer, set top box, cell phone, smartphone, tablet device, smart wearable device, portable media player, video player, etc.

It is understood that the apparatuses described herein may also be applied in other types of apparatuses. Those skilled in the art will appreciate that the various adaptations and modifications of the embodiments of the apparatuses described herein may be configured without departing from the scope and spirit of the present computer apparatuses. Therefore, it is to be understood that, within the scope of the appended claims, the present apparatuses may be practiced other than as specifically described herein.

We claim:

1. A computer program product comprising a computer readable storage device having a computer readable program stored thereon, wherein the computer readable program when executed on a computer causes the computer to:
receive, with a processor from a customer care platform, a request for spoken language interpretation of a user query from a first spoken language to a second spoken language, the first spoken language being spoken by a user situated at an audio-based device that is remotely situated from the customer care platform, the user query being sent from the audio-based device by the user to the customer care platform;
perform, at a language interpretation platform, a first spoken language interpretation of the user query from the first spoken language to the second spoken language;
transmit, from the language interpretation platform to the customer care platform, the first spoken language interpretation so that a customer care representative speaking the second spoken language understands the first spoken language being spoken by the user;
receive, at the language interpretation platform from the customer care platform, a customer care response in the second spoken language;
perform, at the language interpretation platform via a plurality of language interpretation resources, a second spoken language interpretation of the customer care response from the second spoken language to the first spoken language;
generate, with the processor, audio data corresponding to the second spoken language interpretation of the customer care response, the audio data representing a singular voice for the plurality of language interpretation resources; and
transmit, with the processor, the audio data to the customer care platform so that the customer care platform sends the audio data to the audio-based device for consumption at the audio-based device without rendering of audio data in the first spoken language.

2. The computer program product of claim 1, wherein the plurality of language interpretation resources comprise a machine interpreter and a language interpreter.

3. The computer program product of claim 1, wherein the plurality of language interpretation resources comprise a first machine interpreter and a second machine interpreter, the second machine interpreter being trained according to a different skill set than the first machine interpreter.

4. The computer program product of claim 1, wherein the plurality of language interpretation resources comprise a first human interpreter and a second human interpreter, the second human interpreter being trained according to a different skill set than the first human interpreter.

5. The computer program product of claim 1, wherein the computer is further caused to monitor the second spoken language interpretation for compliance with one or more quality control criteria.

6. The computer program product of claim 5, wherein the one or more quality control criteria comprise speed and accuracy.

7. The computer program product of claim 5, wherein the computer is further caused to transition the second spoken language interpretation from a first language interpretation resource in the plurality of language interpretation resources to a second language interpretation resource in the plurality of language interpretation resources during a presentation to the user of the second language interpretation according to the singular voice.

8. The computer program product of claim 1, wherein the audio-based device is a telephone.

9. The computer program product of claim 1, wherein the audio-based device is a microphone.

10. The computer program product of claim 1, wherein the audio-based device is a computing device.

11. A method comprising:
receiving, with a processor from a customer care platform, a request for spoken language interpretation of a user query from a first spoken language to a second spoken language, the first spoken language being spoken by a user situated at an audio-based device that is remotely situated from the customer care platform, the user query being sent from the audio-based device by the user to the customer care platform;
performing, at a language interpretation platform, a first spoken language interpretation of the user query from the first spoken language to the second spoken language;
transmitting, from the language interpretation platform to the customer care platform, the first spoken language interpretation so that a customer care representative speaking the second spoken language understands the first spoken language being spoken by the user;
receiving, at the language interpretation platform from the customer care platform, a customer care response in the second spoken language;
performing, at the language interpretation platform via a plurality of language interpretation resources, a second spoken language interpretation of the customer care response from the second spoken language to the first spoken language;
generating, with the processor, audio data corresponding to the second spoken language interpretation of the customer care response, the audio data representing a singular voice for the plurality of language interpretation resources; and
transmitting, with the processor, the audio data to the customer care platform so that the customer care platform sends the audio data to the audio-based device for consumption at the audio-based device without rendering of audio data in the first spoken language.

12. The method of claim 11, wherein the plurality of language interpretation resources comprise a machine interpreter and a language interpreter.

13. The method of claim 11, wherein the plurality of language interpretation resources comprise a first machine interpreter and a second machine interpreter, the second machine interpreter being trained according to a different skill set than the first machine interpreter.

14. The method of claim 11, wherein the plurality of language interpretation resources comprise a first human interpreter and a second human interpreter, the second human interpreter being trained according to a different skill set than the first human interpreter.

15. The method of claim 11, further comprising monitoring the second spoken language interpretation for compliance with one or more quality control criteria.

16. The method of claim 15, wherein the one or more quality control criteria comprise speed and accuracy.

17. The method of claim 15, further comprising transitioning the second spoken language interpretation from a first language interpretation resource in the plurality of language interpretation resources to a second language interpretation resource in the plurality of language interpretation resources during a presentation to the user of the second language interpretation according to the singular voice.

18. The method of claim 11, wherein the audio-based device is a telephone.

19. The method of claim 11, wherein the audio-based device is a microphone.

20. The method of claim 11, wherein the audio-based device is a computing device.
